(19) United States
(12) Patent Application Publication
(10) Pub. No.: US 2017/0193963 A1
(43) Pub. Date: Jul. 6, 2017

(54) ARRAY SUBSTRATE, DISPLAY PANEL, DISPLAY DEVICE AND METHOD FOR DRIVING THE SAME

(71) Applicants: BOE Technology Group Co., Ltd., Beijing (CN); Hefei Xinsheng Optoelectronics Technology Co., Ltd., Anhui (CN)

(72) Inventors: Yanjiao Pan, Beijing (CN); XiaoPeng Liu, Beijing (CN); Tao Ma, Beijing (CN)

(21) Appl. No.: 15/233,129

(22) Filed: Aug. 10, 2016

(30) Foreign Application Priority Data
Jan. 4, 2016 (CN) 201610004736.5

(51) Int. Cl. G09G 5/02

(52) U.S. Cl. CPC G09G 5/02; G09G 2300/0426; G09G 2320/0666

(57) ABSTRACT

The present disclosure provides an array substrate, a display panel, a display device and a method for driving the display device. The array substrate comprises a display area, a non-display area located around the display area, and a plurality of gate lines and a plurality of data lines at least arranged within the display area, the gate lines and the data lines crossing one another so as to divide the display area into a plurality of display pixel units; the array substrate further comprises at least one supplementary pixel unit provided within the non-display area and configured to receive a driving signal corresponding to the supplementary pixel unit before the display pixel unit located adjacent to the supplementary pixel unit receives a driving signal for displaying an image, thereby enabling reduction in color shift and improvement of display effect.

### CROSS-REFERENCE TO RELATED APPLICATION

This application claims the benefit of the Chinese Patent Application No. 201610004736.5 filed on Jan. 4, 2016 in the State Intellectual Property Office of China, the whole disclosure of which is incorporated herein by reference.

### BACKGROUND OF THE INVENTION

Field of the Invention

Embodiments of the present disclosure generally relate to the field of display technologies, and particularly, to an array substrate, a display panel, a display device and a method for driving the display device.

Description of the Related Art

When an image is displayed by a display panel, a scan signal is provided by a gate drive circuit to respective gate lines on an array substrate sequentially. After a first one of two adjacent gate lines has been scanned, a second one of the two adjacent gate lines will be scanned after a horizontal blanking time has elapsed. Voltage data signals are provided to respective data lines from a source drive circuit during scanning each gate line, and after a last set of data signals has been outputted, data for a next frame restarts to be outputted after a vertical blanking time (V-blanking time) has elapsed. Loads on the gate drive circuit and the source drive circuit are floated during the horizontal blanking time and the vertical blanking time, and certain loads will be again loaded onto the gate drive circuit and the source drive circuit when scanning a first gate line and proving the voltage data signal to a first row of pixel units during displaying the next frame. Thus, a sudden change in load will occur and cause ripple to occur in the voltages outputted to the pixel units, which will result in color shift in the displayed image. When displaying the image in a forward scanning manner, the top of the image is blank (within S region) as shown in FIG. 1 and FIG. 2.

### SUMMARY

An object of the present disclosure is to provide an array substrate, a display panel, a display device and a method for driving the display device, for reducing or eliminating the color shift in the display panel.

In an aspect of the present disclosure, there is provided an array substrate, comprising a display area, a non-display area located around the display area, and a plurality of gate lines and a plurality of data lines at least arranged within the display area, the gate lines and the data lines crossing one another so as to divide the display area into a plurality of display pixel units; the array substrate further comprises at least one supplementary pixel unit provided within the non-display area and configured to receive a driving signal corresponding to the supplementary pixel unit before the display pixel unit located adjacent to the supplementary pixel unit receives a driving signal for displaying an image.

Preferably, the array substrate may further comprise or be provided with a supplementary scan line connected with a corresponding one of the at least one supplementary pixel unit and configured to transmit a scan signal to the corresponding one of the at least one supplementary pixel unit.

Preferably, the supplementary pixel unit may comprise a thin film transistor and a pixel electrode, the thin film transistor having a gate connected with the supplementary scan line and a source connected with a corresponding data line and the pixel electrode.

Preferably, the array substrate may comprise at least one row of the supplementary pixel units arranged within the non-display area, each row of the supplementary pixel units being located adjacent to only one row of the display pixel units in a column direction.

Preferably, the array substrate may further comprise or be provided with a supplementary scan line connected with a corresponding row of the supplementary pixel unit and configured to transmit a scan signal to the corresponding row of the supplementary pixel unit.

Preferably, the supplementary pixel unit is defined by the supplementary scan line and a portion of the data line extending within the non-display area.

Preferably, the supplementary scan line is arranged in the same layer as the gate line.

Preferably, the array substrate may further comprise or be provided with a gate drive circuit comprising a shift register, which comprises cascaded multi-stage shift register units including a shift register unit configured to provide a scan signal to the supplementary scan line and a shift register unit configured to provide a scan signal to the gate line.

In another aspect of the present disclosure, there is provided a display panel, comprising the array substrate as described above.

Preferably, the display panel may further comprise a color filter substrate arranged to be assembled together with the array substrate and a liquid crystal layer arranged between the array substrate and the color filter substrate, the color filter substrate being provided with a plurality of color filter units corresponding to the plurality of display pixel units in a one-to-one relationship.

In a further aspect of the present disclosure, there is provided a display device, comprising the above display panel and a source drive circuit configured to provide voltage data signals to the plurality of data lines respectively.

Preferably, the display device further comprises a frame provided at the periphery of the display panel to cover the non-display area of the array substrate.

In a still further aspect of the present disclosure, there is provided a method for driving the above display device, wherein the method comprises: when displaying a frame of an image,

providing a driving signal to the supplementary pixel unit, and

then, providing a scan signal to respective gate lines in turn from the gate line at a side of the display area adjacent to the supplementary pixel unit to the gate line at a side of the display area away from the supplementary pixel unit, and providing voltage data signals to the respective data lines in accordance with the image to be displayed while providing the scan signal to each of the gate lines.

Preferably, providing a driving signal to the supplementary pixel unit comprises providing voltage data signals to the respective data lines while providing the scan signal to the supplementary scan line.

Preferably, when displaying the same frame of the image, the voltage data signals provided to the respective data lines while providing the scan signal to the supplementary scan line are respectively the same as the voltage data signals provided to the respective data lines while providing the scan signal to the gate line located adjacent to the supplementary scan line.

In the present disclosure, the supplementary pixel unit is provided within the non-display area, such that when displaying a frame of an image, a driving signal is firstly provided to the supplementary pixel unit, and then driving signals are provided to the display pixel units in accordance with the image to be displayed. There is a smaller difference in load between the supplementary pixel unit and the display pixel unit, so that when the display pixel unit which firstly receives the driving signal (that is, the display pixel unit located adjacent to the supplementary pixel unit) displays the image, no sudden change will occur in load of the drive circuit, thereby avoiding occurrence of the ripple in output signal due to sudden change in load, reducing color shift within the display area, and improving display effect.

### BRIEF DESCRIPTION OF THE DRAWINGS

The above and other aspects and features of the present invention will become more apparent by describing in detail exemplary embodiments thereof with reference to the accompanying drawings, in which:

FIG. 1 is a schematic diagram showing a display effect of an image displayed by a display panel in prior arts;

FIG. 2 is an enlarged view of a region I shown in FIG. 1;

FIG. 3 is a structural schematic diagram showing an array substrate according to an embodiment of the present disclosure;

FIG. 4 is a structural schematic diagram showing a color filter substrate according to an embodiment of the present disclosure;

FIG. 5 is a schematic diagram showing a connection between a source drive circuit and a display panel of a display device according to an embodiment of the present disclosure; and

FIG. 6 is a schematic diagram showing an overall structure of a display device according to an embodiment of the present disclosure.

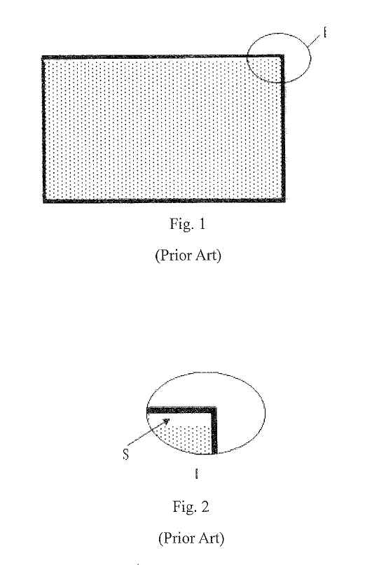

### LIST OF REFERENCE NUMERALS

11: gate line; 12: data line; 13: display pixel unit; 14: supplementary scan line; 15: supplementary pixel unit; 16: gate drive circuit; 2: display panel; 20: color filter substrate; 21: color filter units; 22: black matrix; 32: source drive circuit; 33: frame.

### DETAILED DESCRIPTION OF PREFERRED EMBODIMENTS

Exemplary embodiments of the present invention will be described hereinafter in detail with reference to the attached drawings, wherein the like reference numerals refer to the like elements. The present invention may, however, be embodied in many different forms and should not be construed as being limited to the embodiment set forth herein; rather, these embodiments are provided so that the present invention will be thorough and complete, and will fully convey the concept of the disclosure to those skilled in the art.

In addition, in the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

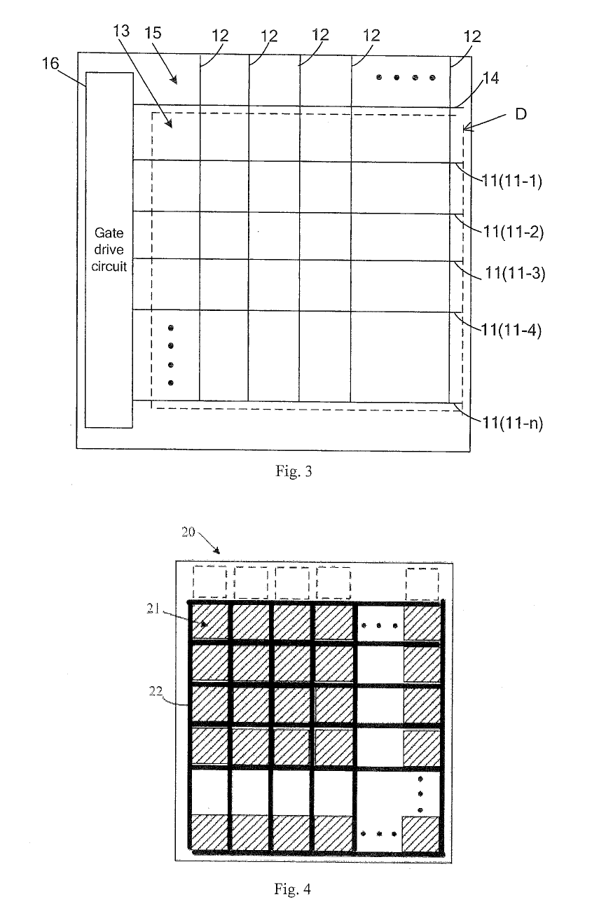

An embodiment of the present disclosure provides an array substrate, as shown in FIG. 3, which comprises a display area D (i.e., an area located within a dashed line frame shown in FIG. 3), a non-display area located around the display area (i.e., an area located outside the dashed line frame shown in FIG. 3), and a plurality of gate lines 11 (including gate lines 11-1, 11-2, 11-3, 11-4 . . . 11-n, where n is an integer larger than or equal to one) and a plurality of data lines 12 at least arranged within the display area; exemplarily, the gate line 11 extends in a row direction, while the data line 12 extends in a column direction; the gate lines 11 and the data lines 12 cross one another, dividing the display area into a plurality of display pixel units 13, as shown in FIG. 3. The array substrate further comprises at least one supplementary pixel unit 15 provided within the non-display area and configured to receive a driving signal corresponding to the supplementary pixel unit 15 before the display pixel unit 13 receives a respective driving signal.

Here, the driving signal is a driving signal for achieving display of an image, including a scan signal and a voltage data signal. The driving signal received by the display pixel unit may be determined dependent on the image to be displayed.

In prior arts, as loads on a gate drive circuit and a source drive circuit are floated during a blanking time between two adjacent frames of the image, while loads loaded onto the gate drive circuit and the source drive circuit when providing the driving signal to the display pixel unit will be larger, ripple will occur in the row of display pixel units which firstly receive the driving signal due to the sudden change in load during displaying a frame of image, which results in a notable color shift at a corresponding position in the displayed image.

In the present disclosure, the supplementary pixel unit 15 is provided within the non-display area, such that, when displaying a frame of an image, a driving signal is firstly provided to the supplementary pixel unit 15, and then corresponding driving signals are provided to the display pixel units 13 in accordance with the image to be displayed. As there is a smaller difference in load between the supplementary pixel unit 15 and the display pixel unit 13, no sudden change will occur in load onto the drive circuit when the display pixel unit 13 which firstly receives the driving signal (that is, the display pixel unit located adjacent to the supplementary pixel unit) displays the image, thereby avoiding occurrence of the ripple in output signal due to the sudden change in load, in turn, reducing color shift within the display area, and improving display performance. Even if ripple occurs in the voltage inputted to the supplementary pixel unit 15, the display effect will not be affected because the supplementary pixel unit 15 is located within the non-display area.

In an example, the driving signal received by the supplementary pixel unit 15 may be the same as the driving signal received by the display pixel unit 13 located adjacent to the supplementary pixel unit, thereby further ensuring stability of the driving signal inputted to the display pixel unit 13.

Further, as shown in FIG. 3, the array substrate may further comprise a supplementary scan line 14 connected with a corresponding supplementary pixel unit 15 and configured to transmit or provide a scan signal to the corresponding supplementary pixel unit 15.

In an example, as shown in FIG. 3, the supplementary scan line 14 may be provided, within the non-display area, in front of the first gate line 11-1 (at the upper side of the first gate line 11-1 or an upper portion of the display area D in a column direction in FIG. 3), such that a plurality of (for example, a row of) the supplementary pixel units 15 are defined, within the non-display area, in front of the first row of display pixel units 13 by the supplementary scan line 14 and the plurality of data lines 12; or a supplementary scan line (not shown) may be provided, within the non-display area, at the rear of or at the lower side of the last gate line 11-n or at the lower portion of the display area D, such that a plurality of (for example, a row of) supplementary pixel units (not shown) are defined, within the non-display area, at the rear of or at the lower side of the last row of display pixel units 13 by the supplementary scan line and the plurality of data lines 12; or, supplementary scan lines are provided, within the non-display area, both in front of the first gate line 11-1 and at the rear of the last gate line 11-n (that is, at the upper side and lower side of the display area), such that a plurality of (for example, at least one row of) supplementary pixel units are defined at both the upper portion and lower portion of the display area by the supplementary scan lines and the data lines. In an example, each supplementary scan line is connected with one row of supplementary pixel units.

If the supplementary scan line 14 is only provide in front of the first gate line 11-1, each frame of an image will be displayed in a forward scanning way, in which a scan signal is firstly provided to the supplementary scan line 14, and then a scan signal is provided to respective gate lines 11 sequentially in an order from the first gate line 11-1 to the last gate line 11-n; if the supplementary scan line is only provide at the rear of the last gate line 11-n, each frame of an image will be displayed in a reverse scanning way, in which a scan signal is firstly provided to the supplementary scan line, and then a scan signal is provided to respective gate lines 11 sequentially in an order from the last gate line to the first gate line.

In order to facilitate arrangement of the supplementary scan line 14, preferably, the supplementary scan line 14 is arranged in the same layer as the gate line 11.

Further, the supplementary scan line 14 may be made of the same material as the gate line 11, such that the supplementary scan line 14 and the gate line 11 may be formed simultaneously when manufacturing the array substrate.

Generally, the display pixel unit 13 is provided therein with a pixel circuit for achieving image displaying, particularly comprising a thin film transistor, a pixel electrode and a common electrode; when an electric field is generated between the pixel electrode and the common electrode, liquid crystal molecules between the array substrate and the color filter substrate will be deflected so as to provide different degrees of transmittance of light. Similarly, the supplementary pixel unit 15 may also be provided therein with a pixel circuit, which comprises, for example, a thin film transistor, a pixel electrode and a common electrode arranged to be insulated and spaced apart from the pixel electrode, wherein the thin film transistor has a gate connected with the supplementary scan line 14 and a source connected with a corresponding data line 12 and the pixel electrode. The supplementary pixel unit 15 receives a corresponding driving signal, that is, a scan signal is provided to the supplementary scan line 14 such that thin film transistors of the plurality of supplementary pixel units 15 defined by the supplementary scan line 14 and the plurality of data lines 12 are switched on, and meanwhile, voltage data signals are respectively provided to the plurality of data lines such that the voltage data signals are received by respective pixel electrodes within the supplementary pixel units 15.

Further, as shown in FIG. 3, the array substrate further comprises a gate drive circuit 16 comprising a shift register (not shown), which comprises cascaded multi-stage shift register units including a shift register unit configured to provide a scan signal to the supplementary scan line 14 and a shift register unit configured to provide a scan signal to the gate line 11. When displaying an image, the multi-stage shift register units output scan signals in sequence such that the supplementary scan line 14 and the plurality of gate lines 11 are scanned sequentially.

An embodiment of the present disclosure provides a display panel, comprising the above array substrate provided in the embodiments of the present disclosure.

In embodiments of the present disclosure, the display panel may be a liquid crystal display panel. Exemplarily, the display panel may further comprise a color filter substrate 20 arranged to be assembled together with the array substrate and a liquid crystal layer arranged between the array substrate and the color filter substrate 20; as shown in FIG. 4, the color filter substrate 20 is provided with a plurality of color filter units (for example, photoresist blocks formed of a photoresist material) 21 corresponding to the plurality of display pixel units 13 in a one-to-one relationship, the color filter units 21 each being configured to filter light from a corresponding display pixel unit such that the corresponding display pixel unit of the display panel displays a color corresponding to the color filter unit. The color filter substrate 20 shown in FIG. 4 will be assembled together with the array substrate shown in FIG. 3, and dashed line frames shown at the upper portion of FIG. 4 correspond to or indicate respective supplementary pixel units 15 on the array substrate.

As shown in FIG. 4, a black matrix 22 is provided between the color filter units 21. Since the supplementary pixel unit 15 is located within the non-display area of the array substrate, no color filter unit is provided at a position of the color filter substrate 20 corresponding to the supplementary pixel unit 15. In order to prevent light leakage at the position of the color filter substrate 20 corresponding to the supplementary pixel unit 15 when the display device displays an image, the black matrix may also be provided at the position of the color filter substrate 20 corresponding to the supplementary pixel unit 15.

Since the supplementary pixel unit is provided within the non-display area of the array substrate and configured to receive a corresponding driving signal prior to the display pixel unit, the sudden change in load on the drive circuit can be reduced when the display pixel unit receives the driving signal to display the image, thereby avoiding occurrence of the ripple in display signal due to the sudden change in load, and enabling the display panel comprising the array substrate to have a better display performance.

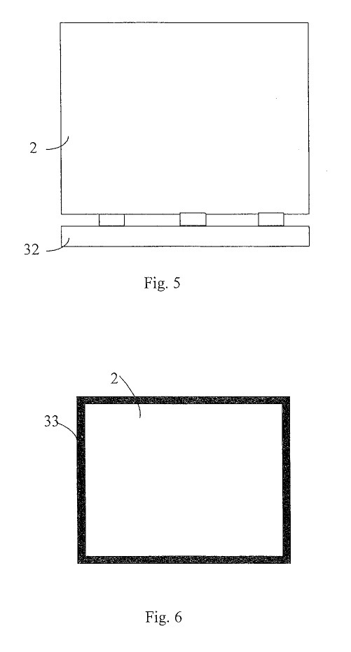

An embodiment of the present disclosure provides a display device, as shown in FIG. 5. The display device comprises a source drive circuit 32 and the display panel 2 according to the embodiments of the present disclosure, and the source drive circuit 32 is configured to provide voltage data signals to the plurality of data lines respectively.

Further, as shown in FIG. 6, the display device may further comprise a frame 33 provided at the periphery of the display panel 2 to cover the non-display area of the array substrate so as to shield the supplementary pixel unit 15. Of course, the display device may further comprise other parts/structures such as a backlight source.

An embodiment of the present disclosure provides a method for driving the display device as described above. The method comprises: when displaying a frame of an image by the display device,

providing a driving signal to the supplementary pixel unit; and

then, providing a scan signal to respective data lines sequentially in a direction from a side of the display area adjacent to the supplementary pixel unit to a side of the display area away from the supplementary pixel unit, and providing voltage data signals to the respective data lines in accordance with the image to be displayed while providing the scan signal to each of the gate lines.

In an example, the array substrate further comprises a supplementary scan line connected with each row of supplementary pixel units in a one-to-one correspondence, and thus in the method, providing a driving signal to the supplementary pixel unit may comprise providing voltage data signals to the respective data lines while providing the scan signal to the supplementary scan line.

As described above, both the display pixel unit and the supplementary pixel unit are provided therein with the pixel electrode, the thin film transistor and the common electrode that is insulated and spaced apart from the pixel electrode. When a scan signal is provided to the supplementary scan line and voltage data signals are provided to respective data lines, the thin film transistors of respective supplementary pixel units corresponding to the supplementary scan line are switched on such that the voltage data signal on the respective data lines are inputted to pixel electrodes within the respective supplementary pixel units. When a scan signal is provided to a gate line and voltage data signals are provided to respective data lines, thin film transistors of a row of display pixel units corresponding to the gate line are switched on such that the voltage data signal on the respective data lines are inputted to pixel electrodes within respective display pixel units, thereby displaying an image.

In general, the array substrate is further provided with a common electrode line that is connected with the common electrode of the display pixel unit. The common electrode line may also be connected with the common electrode of the supplementary pixel unit. When displaying a frame of an image, a common voltage signal is provided to the common electrode line, such that an electric field is generated between the pixel electrode and the common electrode of the supplementary pixel unit when the supplementary scan line is scanned, and an electric field is generated between the pixel electrode and the common electrode of the display pixel unit when the gate line is scanned, thereby liquid crystal molecules between the array substrate and the color filter substrate are deflected.

It is noted that when one gate line is scanned, the voltage data signals provided to respective data lines are determined in accordance with the image to be displayed, such that each row of display pixel units receives corresponding voltage data signals so as to display a complete image.

In an embodiment, when displaying the same frame of the image, the voltage data signals provided to the respective data lines at the time providing the scan signal to the supplementary scan line are respectively the same as the voltage data signals provided to the respective data lines at the time providing the scan signal to the gate line located adjacent to the supplementary scan line. In other words, when displaying the same frame of the image, the voltage data signal provided to each supplementary pixel unit is the same as the voltage data signal provided to the display pixel unit located adjacent to the supplementary pixel unit, such that the voltage data signal received by the display pixel unit which is firstly scanned (that is, display pixel unit located adjacent to the supplementary pixel unit) is kept stable as possible.

Although several exemplary embodiments have been shown and described, it would be appreciated by those skilled in the art that various changes or modifications may be made in these embodiments without departing from the principle and spirit of the disclosure, the scope of which is defined in the claims and their equivalents.

What is claimed is:

1. An array substrate, comprising a display area, a non-display area located around the display area, and a plurality of gate lines and a plurality of data lines at least arranged within the display area, the gate lines and the data lines crossing one another so as to divide the display area into a plurality of display pixel units, wherein
the array substrate further comprises at least one supplementary pixel unit provided within the non-display area and configured to receive a driving signal corresponding to the supplementary pixel unit before the display pixel unit located adjacent to the supplementary pixel unit receives a driving signal for displaying an image.

2. The array substrate according to claim 1, further comprising a supplementary scan line connected with a corresponding one of the at least one supplementary pixel unit and configured to transmit a scan signal to the corresponding one of the at least one supplementary pixel unit.

3. The array substrate according to claim 2, wherein the supplementary pixel unit comprises a thin film transistor and a pixel electrode, the thin film transistor having a gate connected with the supplementary scan line and a source connected with a corresponding data line and the pixel electrode.

4. The array substrate according to claim 1, further comprising at least one row of the supplementary pixel units arranged within the non-display area, each row of the supplementary pixel units being located adjacent to only one row of the display pixel units in a column direction.

5. The array substrate according to claim 4, further comprising a supplementary scan line connected with a corresponding row of the supplementary pixel unit and configured to transmit a scan signal to the corresponding row of the supplementary pixel unit.

6. The array substrate according to claim 2, wherein the supplementary pixel unit is defined by the supplementary scan line and a portion of the data line extending within the non-display area.

7. The array substrate according to claim 5, wherein the supplementary pixel unit is defined by the supplementary scan line and a portion of the data line extending within the non-display area.

8. The array substrate according to claim 2, wherein the supplementary scan line is arranged in the same layer as the gate line.

9. The array substrate according to claim 2, further comprising a gate drive circuit comprising a shift register, which comprises cascaded multi-stage shift register units, the cascaded multi-stage shift register units including a shift register unit configured to provide a scan signal to the supplementary scan line and a shift register unit configured to provide a scan signal to the gate line.

10. A display panel, comprising the array substrate according to claim 1.

11. The display panel according to claim 10, wherein the array substrate further comprises a supplementary scan line connected with a corresponding one of the at least one supplementary pixel unit and configured to transmit a scan signal to the corresponding one of the at least one supplementary pixel unit.

12. The display panel according to claim 11, wherein the supplementary pixel unit is defined by the supplementary scan line and a portion of the data line extending within the non-display area.

13. The display panel according to claim 10, further comprising a color filter substrate arranged to be assembled together with the array substrate and a liquid crystal layer arranged between the array substrate and the color filter substrate, the color filter substrate being provided with a plurality of color filter units corresponding to the plurality of display pixel units in a one-to-one relationship.

14. A display device, comprising the display panel according to claim 10 and a source drive circuit configured to provide voltage data signals to the plurality of data lines respectively.

15. The display device according to claim 14, wherein the array substrate further comprises a supplementary scan line connected with a corresponding one of the at least one supplementary pixel unit and configured to transmit a scan signal to the corresponding one of the at least one supplementary pixel unit.

16. The display device according to claim 14, wherein the display panel further comprises a color filter substrate arranged to be assembled together with the array substrate and a liquid crystal layer arranged between the array substrate and the color filter substrate, the color filter substrate being provided with a plurality of color filter units corresponding to the plurality of display pixel units in a one-to-one relationship.

17. The display device according to claim 14, further comprising a frame provided at the periphery of the display panel to cover the non-display area of the array substrate.

18. A method for driving the display device according to claim 14, wherein the method comprises: when displaying a frame of an image by the display device,
providing a driving signal to the supplementary pixel unit;
then, providing a scan signal to respective gate lines in turn from the gate line at a side of the display area adjacent to the supplementary pixel unit to the gate line at a side of the display area away from the supplementary pixel unit, and providing voltage data signals to the respective data lines in accordance with the image to be displayed while providing the scan signal to each of the gate lines.

19. The method according to claim 18, wherein the array substrate further comprises a supplementary scan line connected with a corresponding one of the at least one supplementary pixel unit, and providing a driving signal to the supplementary pixel unit comprises providing voltage data signals to the respective data lines while providing the scan signal to the supplementary scan line.

20. The method according to claim 19, wherein when displaying the same frame of the image, the voltage data signals provided to the respective data lines at the time providing the scan signal to the supplementary scan line are respectively the same as the voltage data signals provided to the respective data lines at the time providing the scan signal to the gate line located adjacent to the supplementary scan line.
